(19) United States
(12) Patent Application Publication
(10) Pub. No.: US 2015/0317543 A1
(43) Pub. Date: Nov. 5, 2015

(54) PRINTING APPARATUS, PRINTING CONTROL APPARATUS, METHOD FOR CONTROLLING PRINTING APPARATUS, AND STORAGE MEDIUM FOR PRINTING ON TRANSPARENT SHEETS

(71) Applicant: CANON KABUSHIKI KAISHA, Tokyo (JP)

(72) Inventor: Ryo Fujita, Tokyo (JP)

(21) Appl. No.: 14/699,998

(22) Filed: Apr. 29, 2015

(30) Foreign Application Priority Data
May 1, 2014 (JP) 2014-094766

(51) Int. Cl. G06K 15/02

(52) U.S. Cl. CPC G06K 15/023

(57) ABSTRACT

A method for controlling a printing apparatus, including a printing unit for performing printing on a transparent sheet, includes analyzing print data, and extracting a first object to be printed on a front side of the transparent sheet and a second object to be printed on a back side of the transparent sheet, and controlling the printing unit to print image data generated from the extracted first object on the front side of the transparent sheet, convert image data generated from the extracted second object into a mirror image, and print the mirror image on the back side of the transparent sheet.

### BACKGROUND OF THE INVENTION

1. Field of the Invention

The present invention relates to a printing apparatus, a printing control apparatus, a method for controlling the printing apparatus, and a storage medium.

2. Description of the Related Art

Image forming apparatuses for performing image forming include what is called a multi-function peripheral (MFP) having functions of a copying machine, a printer, a scanner, and a facsimile. It is common to configure a printing system in which such image forming apparatuses are connected with a printing control apparatus for performing various image processing related to print job processing and various setting processing, and giving print instructions to the image forming apparatuses. Such printing control apparatuses are called a Digital Front End (DFE) and are provided with various functions similar to image forming apparatuses.

A DFE is connected to enhance functions provided by a MFP and provide DFE-specific functions. Examples of function enhancement include the improvement of print job processing performance. In a case where the DFE is in charge of the interpretation of the Page Description Language (PDL) and the generation of bitmap data, and the MFP prints the generated bitmap data, job printing can be performed more efficiently and quickly than in a case where only the MFP performs all of these operations. Examples of DFE-specific functions include page editing and imposition for a print job, image processing setting, and image forming processing suitable for a sheet type to be used for printing.

Types of print paper (sheets) usable for image forming by the MFP include not only plain paper (what is called copier paper) but also coated paper, label paper, index paper, carbonless paper, and other various types of paper. These special types of paper are used to improve the print quality and give additional values to a printing result. The DFE and the MFP are capable of adjusting image processing parameters and suitably changing the image layout according to the above-described types of print paper.

Some types of print paper are highly transparent. With such types of print paper, an image printed on the back side of a sheet or an image printed on the following page can be seen through. Examples of such print paper include an overhead projector (OHP) film, a polypropylene film, and tracing paper in which the transparency is attained by the material property or the thinness of paper.

There are diverse types of transparent paper having different transparencies. In a case of highly transparent paper, an image on the back side is seen through as it is. Or, in a case of semi-transparent paper having low transparency, an image on the back side may be seen through with a special texture. Hereinafter in the present specification, the above-described highly transparent recording media are referred to as transparent recording media. With respect to image forming on transparent recording media through which an image on the back side or the following page is seen, there have been various image forming methods proposed according to their purposes.

In particular, since an image printed on the back side is seen through when seen from the front side, a certain technique performs mirror image conversion on all or a part of print data to be printed on a transparent recording medium and prints the data on the back side, thus improving the quality of a printing result. For example, Japanese Patent Application Laid-Open No. 2011-112681 discusses an image forming method which is effective for use in advertisement. In the method, the back side of a printed material produced by using a transparent recording medium is irradiated with light by a light source.

To maintain gradations at low-density regions while maintaining the high density of images, the technique discussed in Japanese Patent Application Laid-Open No. 2011-112681 extracts only high-density regions of images on the front side, performs mirror image conversion on the high-density regions, and prints these regions also on the back side.

However, the technique discussed in Japanese Patent Application Laid-Open No. 2011-112681 is not applicable to a case where it is desirable to make a print in the regions other than high-density regions of print data on the back side in mirror image form. Examples of cases where such a demand arises include a case where it is desirable to produce an image effect specific to an image printed on the back side of a transparent recording medium. Examples of image effects specific to the transparent recording medium include an effect of paper gloss when an image is seen from the front side, and an effect of a blurred image acquired by giving opacity of a transparent recording medium to a printed image. These effects are acquired in a case where print data after mirror image conversion is printed on the back side of a transparent recording medium and a user sees the printed image from the front side through the transparent recording medium. When performing image forming on a recording medium, i.e., when a print material, such as ink or toner used by the MFP is applied on the recording medium, there arises a difference in glossiness of the recording medium between a portion where the print material is placed and a portion where no print material is not placed.

Generally, even in a glossy recording medium, the portion with the print material placed often loses the glossiness.

On the other hand, in a case where print data after mirror image conversion is printed on the back side of a recording material so as to be seen from the front side by the user, the print material is placed on the back side. Therefore, when the user sees the image from the front side, the paper gloss of the recording medium itself is reflected as it is, regardless of the print position of the image. Thus, an effect of higher glossiness can be acquired on the side from which the image is seen. Some transparent recording media are semi-transparent because of the low transparency and retain a color of the paper material, such as white. In a case where an image is printed in mirror image form on the back side of such a print sheet so as to be seen from the front side, the user sees the image with the color of the paper material added to the color of the printed image itself. Thus, an effect of the blurred image can be acquired. To apply such an effect to all or a part of the printed image, regardless of the density, the user may want to specify all or a part of the original print data and print the specified data in mirror image form on the back side of a print sheet.

### SUMMARY OF THE INVENTION

According to an aspect of the present invention, a printing apparatus includes a printing unit configured to perform printing on a transparent sheet, an extraction unit configured to analyze print data, and extract a first object to be printed on a front side of the transparent sheet and a second object to be printed on a back side of the transparent sheet, and a control unit configured to control the printing unit so as to print image data generated from the first object extracted by the extraction unit on the front side of the transparent sheet, convert image data generated from the second object extracted by the extraction unit into a mirror image, and print the mirror image on the back side of the transparent sheet.

Further features of the present invention will become apparent from the following description of exemplary embodiments with reference to the attached drawings.

### BRIEF DESCRIPTION OF THE DRAWINGS

FIG. 1 is a block diagram schematically illustrating a configuration of a printing control apparatus.

FIG. 2 illustrates connections between the printing control apparatus and an image forming apparatus.

FIG. 3 is a block diagram illustrating a configuration of the image forming apparatus illustrated in FIG. 2.

FIG. 4 illustrates a document structure of the Page Description Language (PDL) data.

FIG. 5 is a flowchart illustrating a method for controlling a printing system.

FIG. 6 illustrates an example of a user interface (UI) screen displayed in the printing system.

FIG. 7 illustrates an example of a UI screen displayed in the printing system.

FIG. 8 illustrates a document structure of PDL data.

FIG. 9 is a flowchart illustrating a method for controlling the printing system.

FIG. 10 illustrates a document structure of PDL data.

FIGS. 11A, 11B, 11C, and 11D illustrate a print data processing flow and images resulting from the processing.

### DESCRIPTION OF THE EMBODIMENTS

Exemplary embodiments of the present invention will be described below with reference to the accompanying drawings.

### Descriptions of System

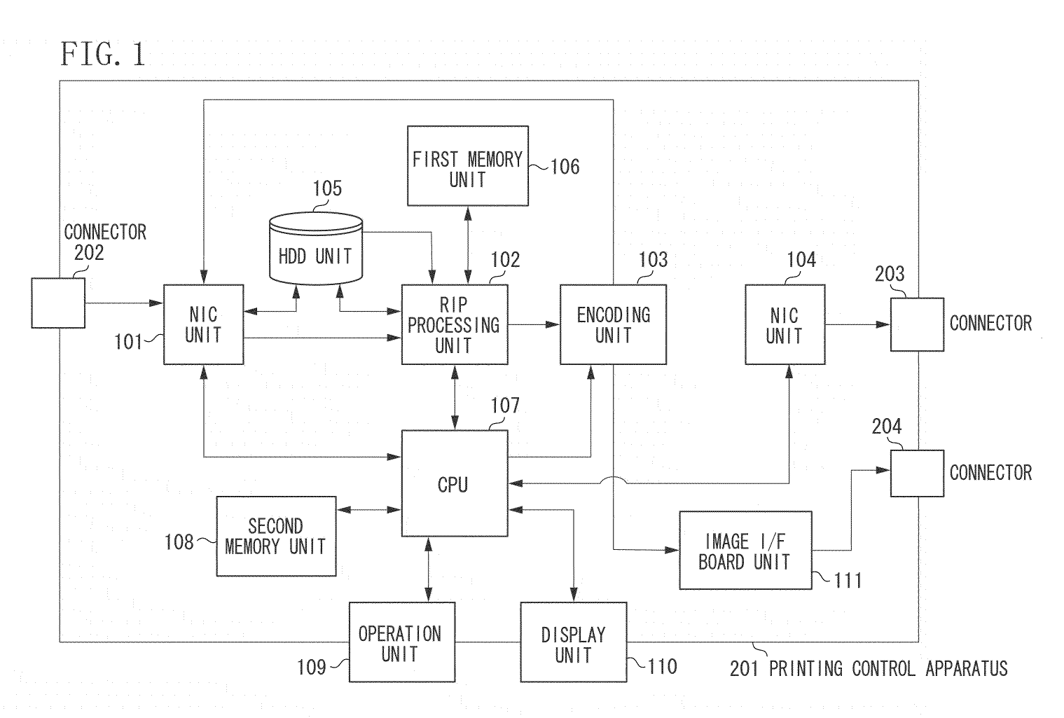

A first exemplary embodiment of the present invention will be described below. Basic operations of a printing system including a printing control apparatus and a printing apparatus will be described below with reference to FIGS. 1, 2, and 3. Although the present exemplary embodiment will be described below as a printing system, the printing apparatus may be provided with functions of the printing control apparatus. In the present exemplary embodiment, the printing system includes an image forming apparatus capable of performing multi-functional processing as an example of a printing apparatus.

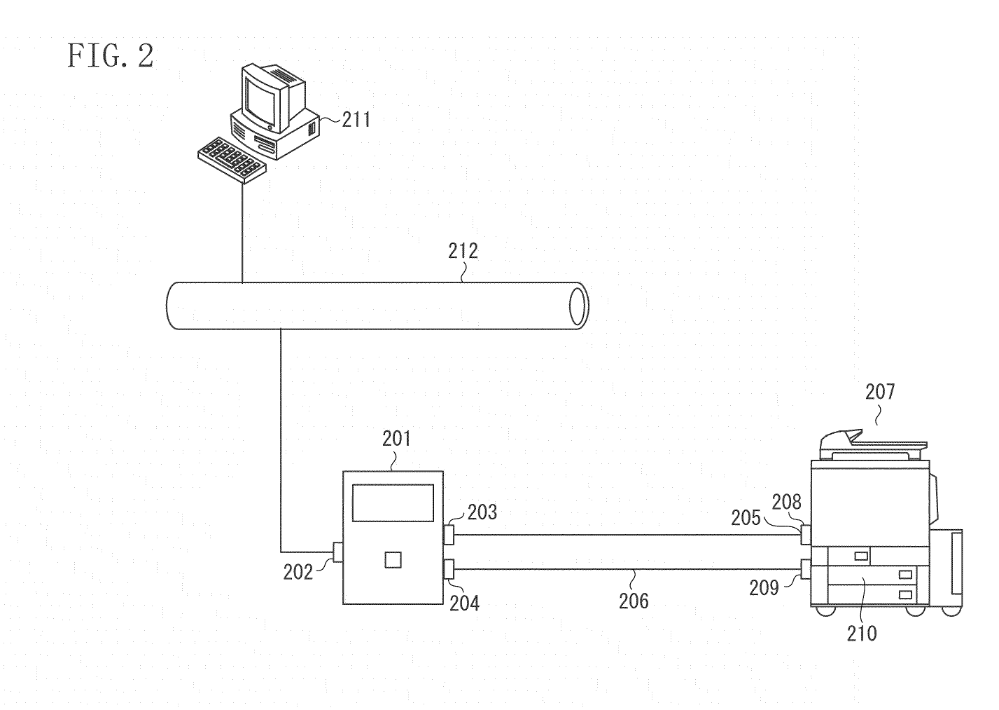

FIG. 1 is a block diagram schematically illustrating a configuration of a printing control apparatus 201 according to the present exemplar embodiment. FIG. 2 illustrates connections between the printing control apparatus 201 and an image forming apparatus 207.

Referring to FIG. 1, the printing control apparatus 201 includes connectors 202, 203, and 204. A network interface card (NIC) unit 101 serves as a first network interface for managing low-level layer connections with a local area network (LAN) 212 illustrated in FIG. 2 via the connector 202.

A raster image processor (RIP) processing unit 102 converts print data described in PDL into raster image data such as bitmap image data.

A NIC unit 104 serves as a second network interface for managing low-level layer connections with a LAN 205 illustrated in FIG. 2 via the connector 203. A hard disk drive (HDD) unit 105 temporarily stores print data received by the NIC unit 101. The HDD unit 105 is able to store various setting value information managed by the printing control apparatus 201. The printing control apparatus 201 can read setting value information from the HDD unit 105 and write to the HDD unit 105 changes of setting value information requested via an external apparatus or an operation unit 109. A first memory unit 106 is used by the RIP processing unit 102 to perform image rasterization processing. A central processing unit (CPU) 107 controls the entire printing control apparatus 201.

A second memory unit 108 is used as a temporarily data storage area by the CPU 107. An operation unit 109 is provided with buttons, keys, and a touch panel necessary to perform operations of the printing control apparatus 201. An image interface board unit 111 uses the connector 204. The printing control apparatus 201 uses the image interface board unit 111 and the connector 204 to transmit image data to the image forming apparatus 207 via an exclusive transmission path 206.

As basic operations of the printing system including the printing control apparatus 201 and the image forming apparatus 207, print processing for a print job input from a terminal unit will be described below.

As illustrated in FIG. 2, a terminal unit 211 is a computer connected to the LAN 212. A plurality of terminal units 211 may exist on the LAN 212. First of all, the terminal unit 211 inputs a print job to the printing control apparatus 201. A network data packet from the terminal unit 211 to the printing control apparatus 201 is transmitted via the LAN 212, and is received by the printing control apparatus 201 via the connector 202. In the printing control apparatus 201, the NIC unit 101 performs data receiving processing.

Upon reception of print data, the CPU 107 performs control to store the received data in the HDD unit 105 as required. This processing is referred to as queuing (spooling) which is generally performed to improve the data transmission rate. Data stored in the HDD unit 105 is read from the RIP processing unit 102 according to an instruction from the CPU 107. Meanwhile, print data not queued is directly transferred to the RIP processing unit 102 according to an instruction from the CPU 107.

Thus, the RIP processing unit 102 performs rasterization imaging processing on the received print data to convert the print data into raster image data. Then, based on the format of the generated raster image data and a preset data format interpretable by the image forming apparatus 207, an encoding unit 103 performs encoding processing on the raster image data to encode the raster image data into a data format interpretable by the image forming apparatus 207.

An example of encoding processing is data compression processing performed to reduce the data amount to be transmitted to the image forming apparatus 207. Such encoding processing is performed when needed. Therefore, if encoding is not necessary, for example, if the generated raster data is interpretable as it is by the image forming apparatus 207 or if the reduction in the data amount is not necessary, the encoding processing may be skipped.

Data after encoding (encoded data) needs to be in a format interpretable by the image forming apparatus 207. The format changes according to the capabilities of an interpretation method included in the image forming apparatus 207, for example, a specific printing language format or a data format compressed by a specific method such as Joint Bi-level Image Experts Group (JBIG).

The data encoded in this way as needed are reconfigured into a data packet by the NIC unit 104 for transmission to the LAN 205, and then is transmitted from the connector 203 to the image forming apparatus 207 via the LAN 205 and the connector 208. Upon reception of the data packet, the image forming apparatus 207 including a plurality of document feeders 210 feeds paper from one of the document feeders 210 and performs print processing according to a print process procedure included therein. As another path for transmitting the encoded data, the encoded data is transferred to the image interface board unit 111 via the encoding unit 103, and then is transmitted from the connector 204 to the image forming apparatus 207 via an exclusive transmission path 206.

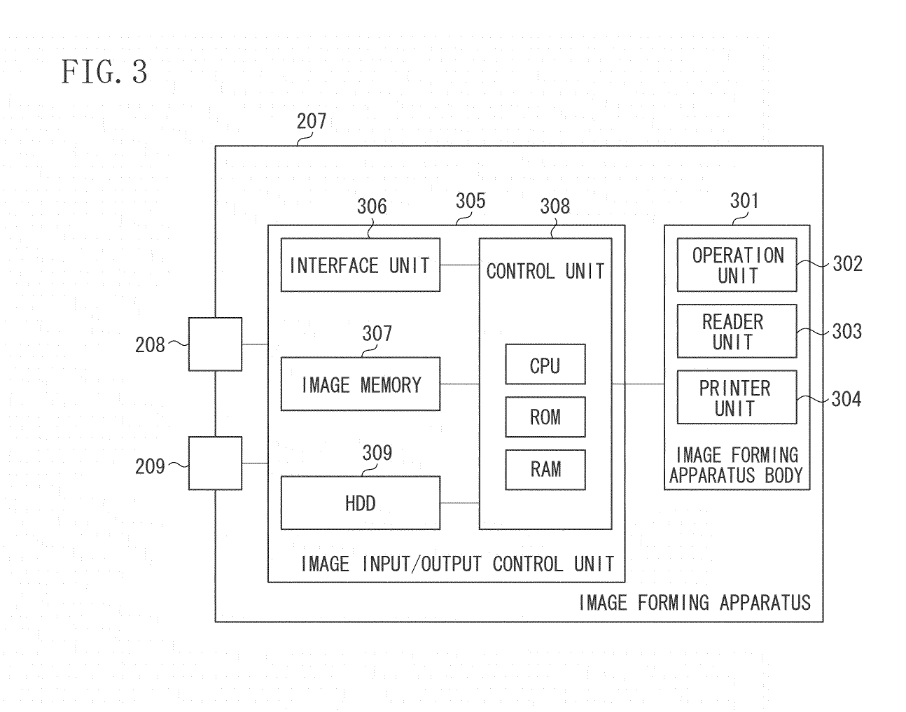

FIG. 3 is a block diagram illustrating a configuration of the image forming apparatus 207 illustrated in FIG. 2. The image forming apparatus 207 for performing print processing will be described below with reference to FIG. 3.

Referring to FIG. 3, the image forming apparatus 207 according to the present exemplary embodiment includes an image forming apparatus body 301 and an image input/output control unit 305.

The image forming apparatus body 301 includes an operation unit 302, a reader unit 303, and a printer unit 304. The operation unit 302 is used to operate the image forming apparatus body 301 and the image input/output control unit 305.

The reader unit 303 reads a document image and outputs image data corresponding to the document image to the printer unit 304 and the image input/output control unit 305. The printer unit 304 records on a recording sheet an image corresponding to the image data received from the reader unit 303 and the image input/output control unit 305.

The image input/output control unit 305 includes an interface unit 306, an image memory 307, a control unit 308, and a hard disk (HDD) 309, and is connected to the reader unit 303. The HDD 309 stores various setting values of the image forming apparatus 207, such as an address book, an operation history, user settings, identifier (ID) settings, and network settings. The interface unit 306 is an interface among the printing control apparatus 201, the terminal unit 211 on the network 212, and the control unit 308.

The interface unit 306 receives encoded image data transmitted from the printing control apparatus 201 via the connector 208 or 209, rasterizes the received data into image data recordable by the printer unit 304, and transfers the image data to the control unit 308. The control unit 308 includes a CPU, a read only memory (ROM), and a random access memory (RAM). The CPU of the control unit 308 loads a program stored in the ROM or other recording medium into the RAM, and executes the program to control data flows among the reader unit 303, the interface unit 306, and image memory 307. Instead of the HDD 309, data may be stored in other nonvolatile memory in which data is retained even after power is turned OFF. This completes descriptions of an overview of the printing control apparatus 201 and the image forming apparatus 207, and basic operations of the printing system including these apparatuses.

An overview of a data structure of print data described in PDL will be described below. A tree structure is a data structure indicating a document configuration of print data described in PDL. In the present exemplary embodiment, the tree structure is expressed by the Extensible Markup Language (XML) format. XML itself is also a PDL and is able to express a document configuration of other PDL data such as the Page Description Format (PDF).

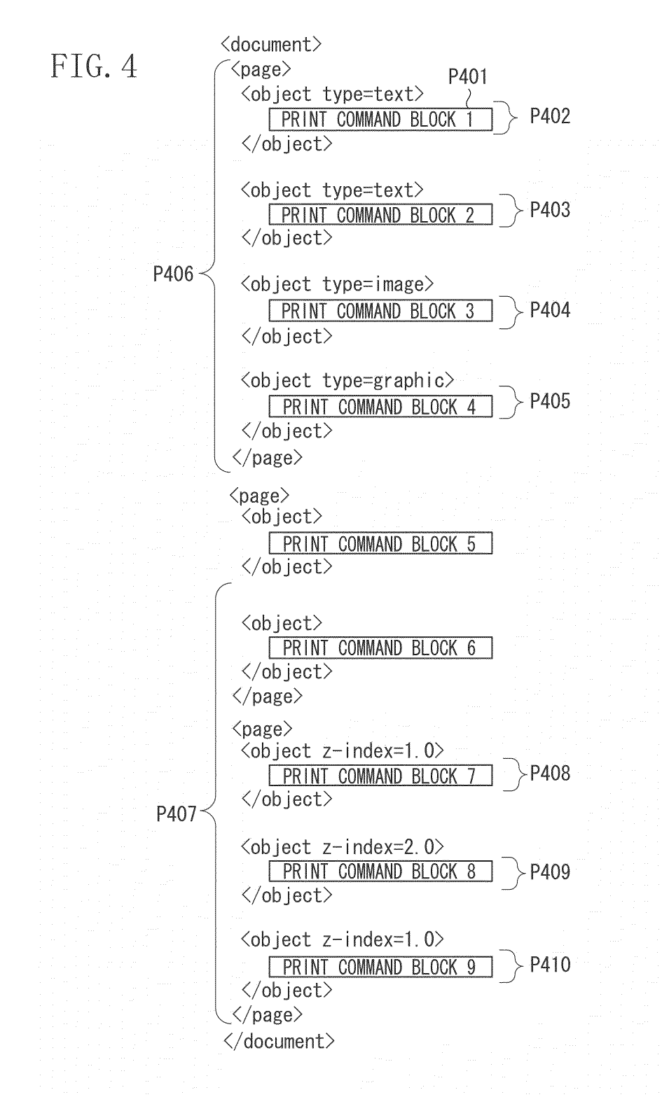

FIG. 4 illustrates an example of XML data expressing a document structure of PDL data. The <document> tag is a root element of the tree structure. A block placed between the <page> tag (a child element of the <document> tag) and the </page> tag corresponds to one page of the PDL data.

A block placed between the <object> tag (a child element of the <page> tag) and the </object> tag corresponds to one image object. An image object refers to a set of print commands. A plurality of print commands and a binary sequence of encoded bitmap data can be described in each print command block such as a print command block P401. More specifically, FIG. 4 illustrates a document structure of the PDL data including three pages. The first, the second, and the third pages include four, two, and three image objects, respectively.

A purpose of collectively handling a plurality of print commands as an image object in this way is to easily specify print processing attribute values for the print commands. The image processing type is an example of a print processing attribute value. Each print command has different characteristics. For example, the “text” type indicates characters, the “graphic” type indicates a rendering command for lines and other graphics, and the “image” type mainly indicates photographs. According to these characteristics, in many cases of raster image generation, the printing control apparatus 201 should perform different color processing and screen processing.

To cope with such cases, it is desirable to provide a method for describing an image processing type provided by each individual print command described in the PDL data. Since many print commands are included in the PDL data, it is convenient to collectively describe image processing types for a plurality of print commands. As an example of implementing this description method, in an object P402 illustrated in FIG. 4, “text” is designated as the “type” attribute value of the “object” element. This means that all of print commands included in the object P402 have the “text” image processing type. Similarly, objects P403, P404, and P405 have the “text”, the “image”, and the “graphic” image processing types (types of objects which should be rendered), respectively.

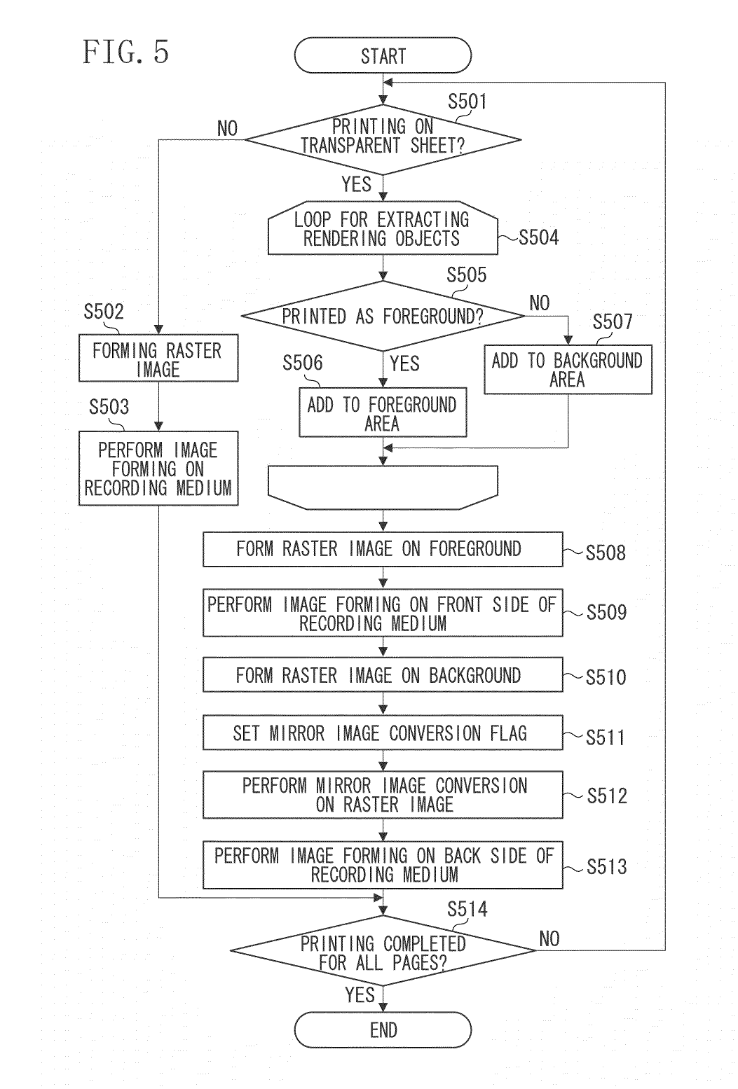

FIG. 5 is a flowchart illustrating a method for controlling the printing system according to the present exemplary embodiment. The following describes an example of processing for forming an image corresponding to print data described in PDL on a transparent recording medium (transparent sheet). Each step of the flowchart is carried out when the CPUs included in the printing control apparatus 201 and the image forming apparatus 207 execute programs stored in the HDDs or the ROM included in the printing control apparatus 201 and the image forming apparatus 207. The flowchart illustrated in FIG. 5 is started at the time of print processing of a print job in the printing system including the printing control apparatus 201 and the image forming apparatus 207 of which an overview was described above.

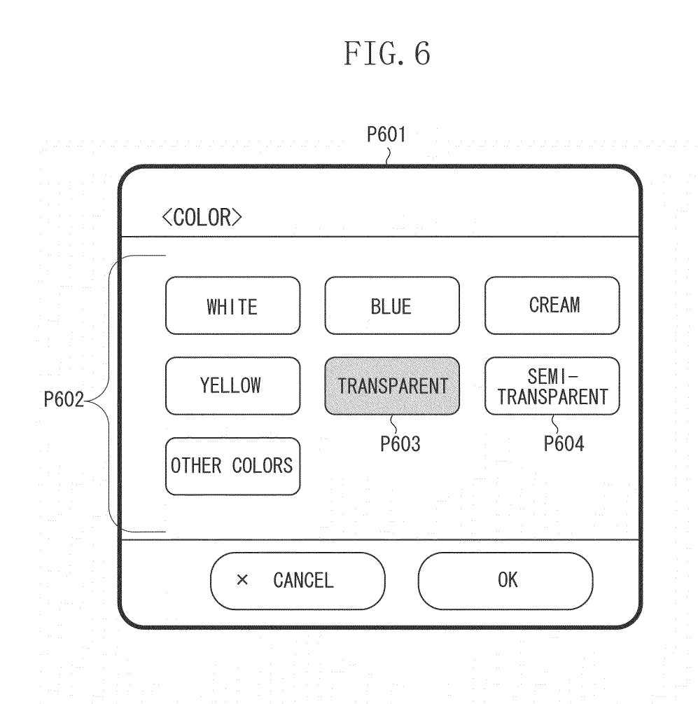

In step S501, the CPU 107 of the printing control apparatus 201 determines whether the paper for image forming at the page on the PDL data to be printed next is a transparent recording medium. Methods for making this determination includes measuring the transparency of the paper by using a sensor device such as an optical sensor provided in the image forming apparatus 207, or a method based on paper color information as one of paper information set in a setting screen as illustrated in FIG. 6.

The printing control apparatus 201 or the image forming apparatus 207 includes the operation units 109 and 302, respectively, as a means for receiving paper information settings. This means enables specifying the type of paper that has been supplied to each of a plurality of the document feeders 210 provided in the image forming apparatus 207. Examples of settable paper information include the paper size, grammage, surface nature, and color.

A screen P601 illustrated in FIG. 6 is an example of a color setting screen. The user can specify the color of the paper supplied to the document feeder 210 by selecting the color corresponding to that of the supplied paper, from options displayed in a display area P602. The screen P601 indicates a state where Transparent P603 is specified. If Transparent P603 or Semi-transparent P604 is selected as the paper supplied to a feed stage to be used for printing (YES in step S501), the printing control apparatus 201 recognizes the paper as a transparent recording medium. Then, the processing proceeds to a loop S504.

On the other hand, if neither Transparent P603 nor Semi-transparent P604 is selected as the paper (NO in step S501), then in step S502, as described above, the printing control apparatus 201 forms a raster image on the print data. In step S503, the image forming apparatus 207 forms an image from the raster image on the recording medium. When the CPU 107 determines that the paper is a transparent recording medium (YES in step S501), the progressing proceeds to the loop S504. In this loop, the CPU 107 performs processing for extracting the foreground to be printed in normal image and extracting the opposite background to be printed in mirror image.

In the present exemplary embodiment, the CPU 107 performs extraction processing according to print settings of a print job. An example of a print setting method will be described below. In the extraction processing, the CPU 107 of the printing control apparatus 201 analyzes the print data, and extracts first objects to be printed on the front side of the transparent sheet and second objects to be printed on the back side of the transparent sheet.

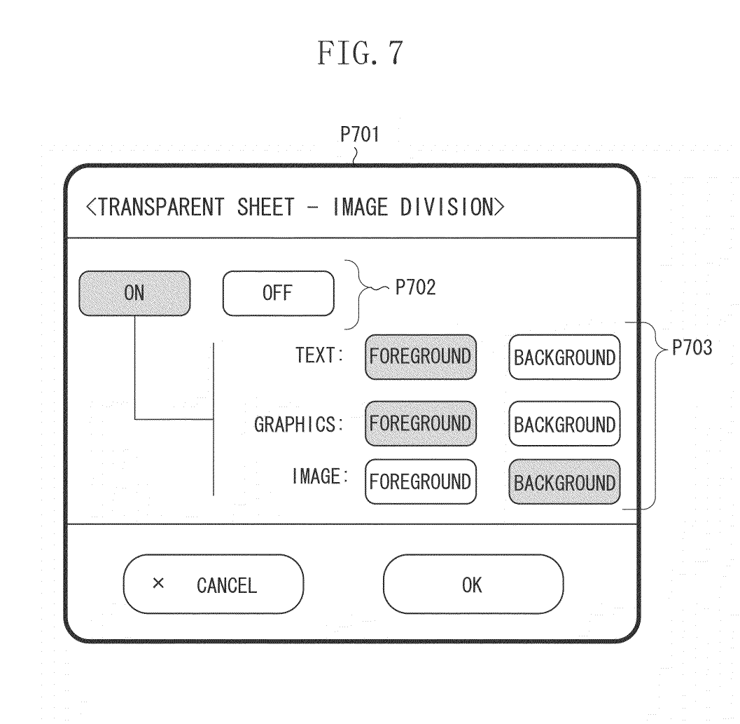

FIG. 7 illustrates an example of a screen for inputting print settings for a print job which can be operated via the operation units 109 and 302 of the printing control apparatus 201 and the image forming apparatus 207, respectively.

Print settings which can be made for a print job include the number of copies, a print page range, an output destination, finishing settings, target paper settings, and image processing settings.

A user interface (UI) screen P701 illustrated in FIG. 7 is an example of a screen for specifying whether each image processing type of objects in the print data is to be handled as the foreground or whether each image processing type is to be handled as the background. The user can enable or disable this function by using buttons P702. When the function is enabled, the user can further set whether to print each image processing type (Text, Graphics, and Image) as the background or the foreground, by using buttons P703. It will be described below on the premise that texts and graphics are specified as the foreground and images are specified as the background. Processing in the loop S504 is repeated for the number of image objects included in the page to be printed on a transparent recording medium.

In step S505, the printing control apparatus 201 determines whether each image object is to be printed as the foreground. This determination is made based on the result of the comparison between the image processing type specified for each image object illustrated in FIG. 4 and the print processing setting illustrated in FIG. 7. Assume that the first page of the PDL data illustrated in FIG. 4 is set to be printed on a transparent recording medium and the second and the third pages of the PDL data are set to be printed on plain paper. In this case, based on the print settings illustrated in FIG. 7, the text objects P402 and P403 and the graphics object P405 are determined to be the “foreground” and the image object P404 is determined to be the “background.”

It is assumed that a default operation is preset in the printing control apparatus 201 in case the image processing type attribute is not set to an object. In this case, if the image processing type attribute is not set to an object, the printing control apparatus 201 determines that the object is the “foreground” as a default operation. When the image object is determined to be the “foreground” (YES in step S505), then in step S506, the printing control apparatus 201 adds the object to the foreground. On the other hand, when the image object is determined to be the “background” (NO in step S505), then in step S507, the printing control apparatus 201 adds the object to the background.

In the present exemplary embodiment, the foreground is PDL data for one page including image objects to be printed as the “foreground”, and the background is PDL data for one page including image objects to be printed as the “background.”

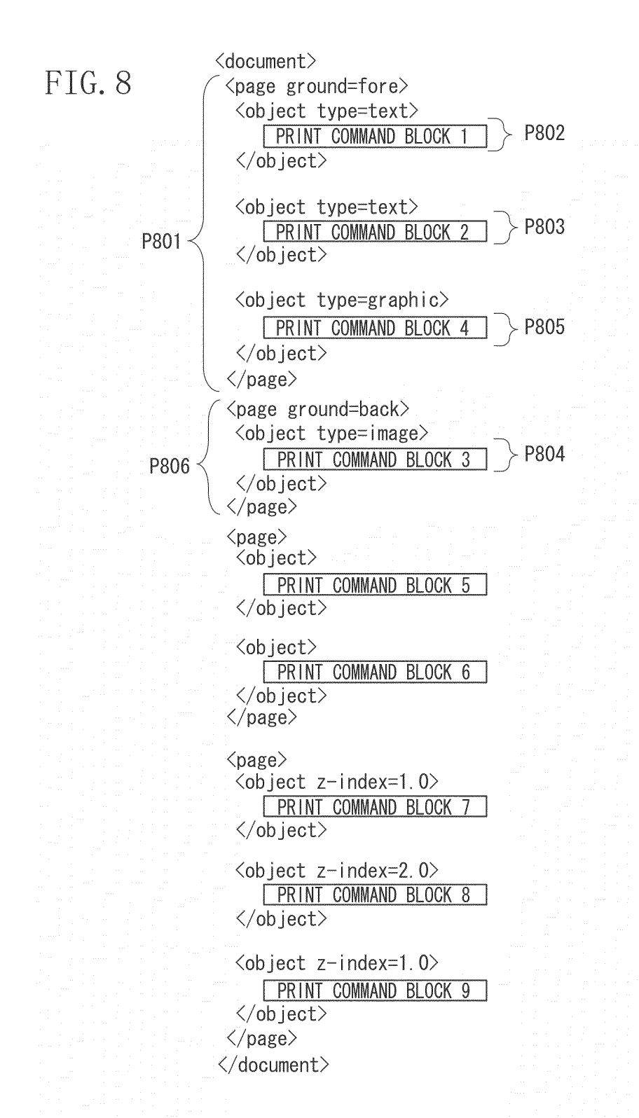

More specifically, in steps S506 and S507, the printing control apparatus 201 moves the image object determined to be the “foreground” to a page corresponding to the foreground, and moves the image object determined to be the “background” to a page corresponding to the background, respectively. FIG. 8 illustrates PDL data acquired when the above-described determination is completed for all of image objects in the PDL data illustrated in FIG. 4.

A page P801 corresponds to the foreground and a page P806 corresponds to the background. A value “fore” indicating the “foreground” and a value “back” indicating the “background” are stored in the “ground” attribute value for distinguishing between the foreground and the background.

The objects arranged in a page P406 illustrated in FIG. 4 are stored in the pages P801 and P806. Objects P802, P803, and P805 have the same contents as the objects P402, P403, and P405 illustrated in FIG. 4, respectively, and are stored in the foreground page P801 since the these objects are determined to be the “foreground.” An object P804 has the same contents as the object P404 determined to be the “background”, and is stored in the page P806 corresponding to the background.

In step S508, the RIP processing unit 102 forms a raster image on the page corresponding to the foreground, and transmits the raster image to the image forming apparatus 207. In step S509, the image forming apparatus 207 forms the image on one side of a transparent recording medium by using the received raster image. In step S510, the RIP processing unit 102 of the printing control apparatus 201 forms a raster image on the page corresponding to the background, and transmits the raster image to the image forming apparatus 207.

When forming the raster image on a page, the RIP processing unit 102 does not perform mirror image conversion. In step S511, the RIP processing unit 102 transmits the raster image to the image forming apparatus 207, and sets a mirror image conversion flag in the transmit data. In step S512, since the mirror image conversion flag is set in the received raster image, the image forming apparatus 207 performs mirror image conversion on the raster image. In step S513, by using the raster image after mirror image conversion, the image forming apparatus 207 forms the image on the side of the transparent recording medium opposite to the side on which the foreground was formed.

This completes processing for dividing the PDL data for one page into the foreground and the background, and printing the PDL data on different sides of the same transparent recording medium. In step S514, the printing control apparatus 201 determines whether printing has been completed for all pages. If printing has not been completed (NO in step S514), the processing returns to step S501. Then, the printing control apparatus 201 repeats the above-described processing. This completes descriptions of the method of image forming for print data on a transparent recording medium according to the present exemplary embodiment.

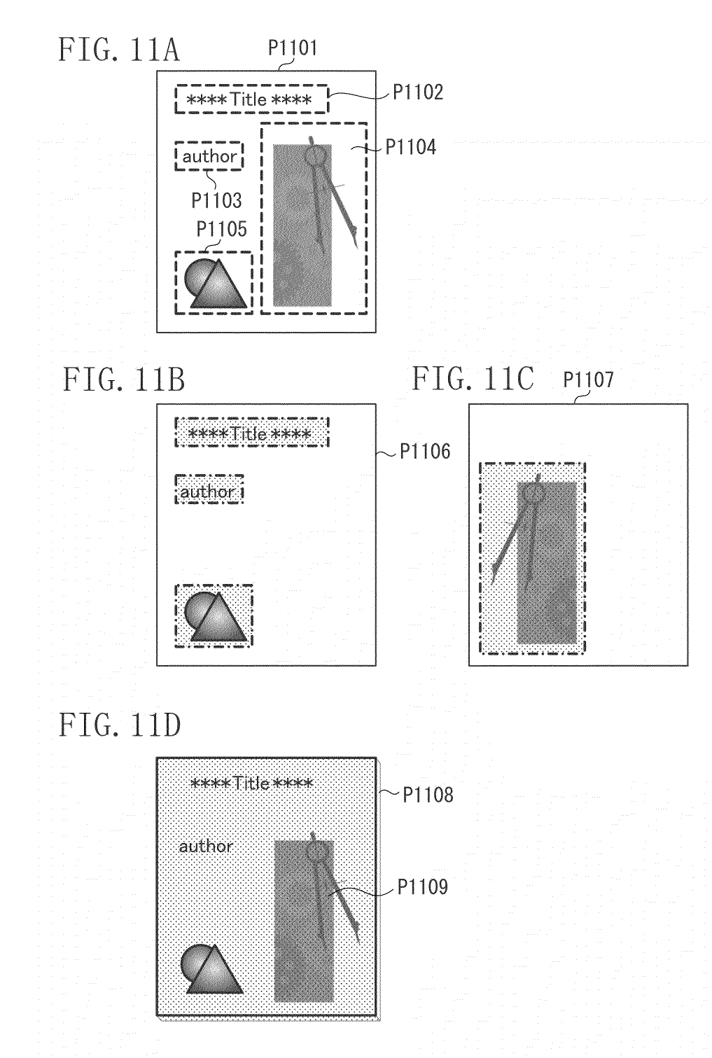

FIGS. 11A, 11B, 11C, and 11D illustrate a print data processing flow and images resulting from the above-described processing. FIG. 11A illustrates PDL data to be used for printing. A transparent recording medium P1101 indicates the first page of the PDL data of which the document structure is illustrated in FIG. 4. Image objects P1102, P1103, P1104, and P1105 enclosed by dashed lines indicate the objects P402, P403, P404, and P405, respectively, illustrated in FIG. 4.

In the above-described example, a print job is set to print the print data as the background only when the image processing type is “image.” In this case, only the image object P1104 is selected as the background, and the image forming apparatus 207 generates bitmap data for image forming as illustrated in FIGS. 11B and 11C. Shaded regions with dots indicate regions in which bitmap images corresponding to image objects stored in the PDL data illustrated in FIG. 11A exist.

Bitmap data P1106 corresponds to the foreground, which has been produced as a raster image by the printing control apparatus 201 in step S508 of the flowchart illustrated in FIG. 5. Bitmap data P1107 corresponds to the background, which has been produced to be a raster image by the printing control apparatus 201 in steps S510 and through mirror image conversion by the image forming apparatus 207 in step S512. The bitmap data P1107 is produced by performing mirror image conversion on the image object P1104 in FIG. 11A in terms of the position and rendering contents. The image forming apparatus 207 forms the image on the bitmap data P1106 and P1107 on both sides of the same transparent recording medium in steps S509 and S513 to obtain objects illustrated in FIG. 11D. A transparent recording medium P1108 is a recording medium on which an image has been formed. FIG. 11D illustrates the transparent recording medium P1108 seen from the side on which an image of the foreground bitmap data P1106 has been formed.

Although the layout of image objects conforms to the PDL data illustrated in FIG. 11A, only the image object P1104 is printed on the back side of the transparent recording medium. As a result, at a region P1109 on the front side of the transparent recording medium, the glossiness of the transparent recording medium is reflected as it is. If the transparency of the transparent recording medium P1108 is not high, the paper color of the transparent recording medium is reflected which has a blurred effect on the image object P1104. Thus, image effects specific to transparent recording media, such as a gloss effect and a blur effect, can be given only to specific regions of the original PDL data P1101.

The effects brought by the method according to the present exemplary embodiment will be described below. Among image objects described on the same page of the print data, some image objects are printed in normal image form on the front side as the foreground, and other image objects are printed in mirror image form on the back side as the background. Image effects specific to transparent recording media, such as the above-described gloss effect and blur effect, can be acquired at the regions on which image objects are printed in mirror image form on the back side of the transparent recording medium. More specifically, image effects specific to transparent recording media can be given only to specific regions of the print data.

A second exemplary embodiment of the present invention will be described below. In the method for performing image forming for print data on a transparent recording medium (transparent sheet) according to the first exemplary embodiment, the image forming apparatus 207 divides the print data into the foreground and the background based on the print settings set by the user, and then performs mirror image conversion on raster images corresponding to the background. While this method enables specifying the foreground and the background through the print settings, setting needs to be made for each print job. Although, in the first exemplary embodiment, the image forming apparatus 207 performs mirror image conversion, it may be preferable that the printing control apparatus 201 performs mirror image conversion in a case where, for example, the printing control apparatus 201 has higher processing speed than the image forming apparatus 207.

According to another exemplary embodiment of the present embodiment, in view of the foregoing aspects, the printing control apparatus 201 automatically divides print data into the foreground and the background, and then generates raster images after mirror image conversion. Then, image forming of print data on a transparent recording medium is achieved by using the above-described processing, as described below.

Attribute values on the PDL data to be used in the image forming on a transparent recording medium according to the present exemplary embodiment will be described below with reference to FIG. 4. The “z-index” attribute is set in each of objects P408, P409, and P410 in the PDL data illustrated in FIG. 4.

This attribute indicates the rendering order of overlapping image objects. An object having a larger z-index value is rendered over an object having a smaller z-index value. Image objects having the same z-index value are rendered in order of appearance within the PDL data.

More specifically, the objects P408, P409, and P410 illustrated in FIG. 4 are overlapping in order of the objects P408, P410, and P409 from the bottom upward. In the present exemplary embodiment, the image forming apparatus 207 forms the image based on the z-index attribute value. More specifically, among the image objects in the PDL data, overlapping objects on the upper side are rendered in the foreground and overlapping objects on the lower side are rendered in the background, as described below.

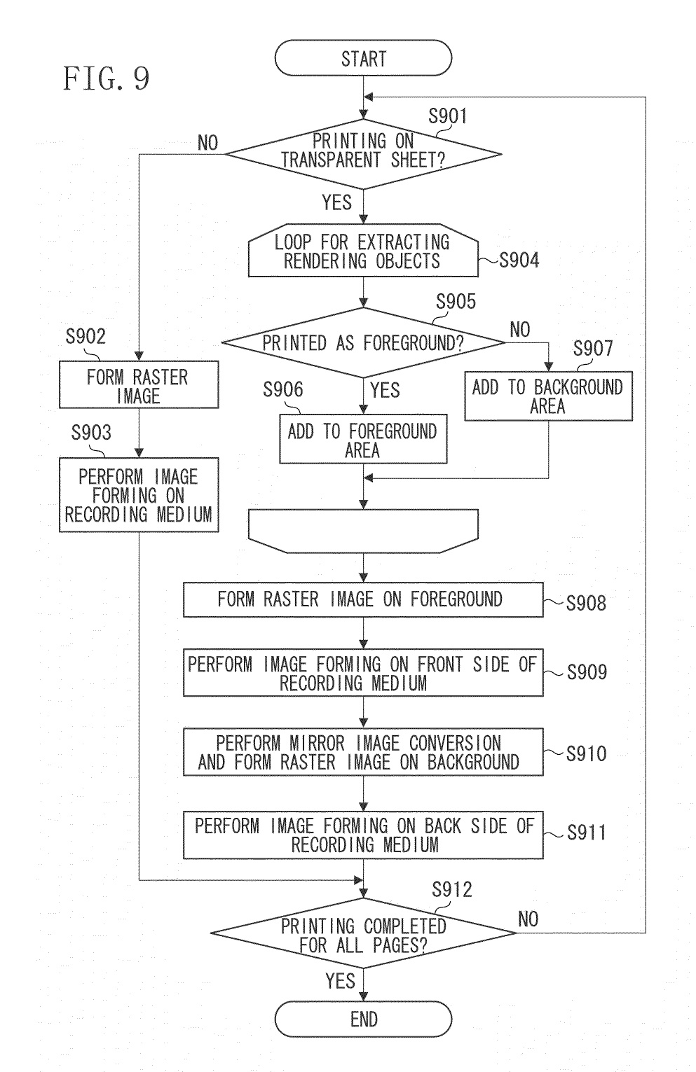

A method of image forming on a transparent recording medium according to the present exemplary embodiment will be described below with reference to the flowchart illustrated in FIG. 9.

FIG. 9 is a flowchart illustrating a method for controlling the printing system according to the present exemplary embodiment. The present exemplary embodiment is realized when the CPUs included in the printing control apparatus 201 illustrated in FIG. 1 and the image forming apparatus 207 illustrated in FIG. 3 execute programs stored in the HDDs or the ROM included in the printing control apparatus 201 and the image forming apparatus 207.

Processing in steps S901, S902, and S903 illustrated in FIG. 9 is similar to the processing in steps S501, S502, and S503 illustrated in FIG. 5, respectively, therefore, redundant descriptions thereof will be omitted.

When the CPU 107 of the printing control apparatus 201 determines that the next page of the PDL data will be printed on a transparent recording medium (YES in step S901), the processing proceeds to a loop S904. Processing in the loop S904 is repeated a number of image objects included in the page. In step S905, the CPU 107 of the printing control apparatus 201 determines whether each image object is to be printed as the “foreground.” In this case, among the image objects included in the page, an image object having the largest z-index value is to be printed in the “foreground”, and other image objects are to be printed in the background.

Subsequently, similar to the first exemplary embodiment, in steps S906 and S907, the CPU 107 stores in the foreground page the object to be printed in the foreground, and stores in the background page the objects to be printed in the background, respectively.

More specifically, in step S905, the CPU 107 compares z-index of the current image object with z-index of each image object stored in the foreground page. If the two z-index values are identical, the printing control apparatus 201 adds the current image object to the foreground page. If z-index of the current image object is larger than the other z-index, the CPU 107 moves all of the image objects on the foreground page to the background page, and adds only the current image object to the foreground page. On the other hand, if z-index of the current image object is smaller than the other z-index, the CPU 107 adds the current image object to the background page.

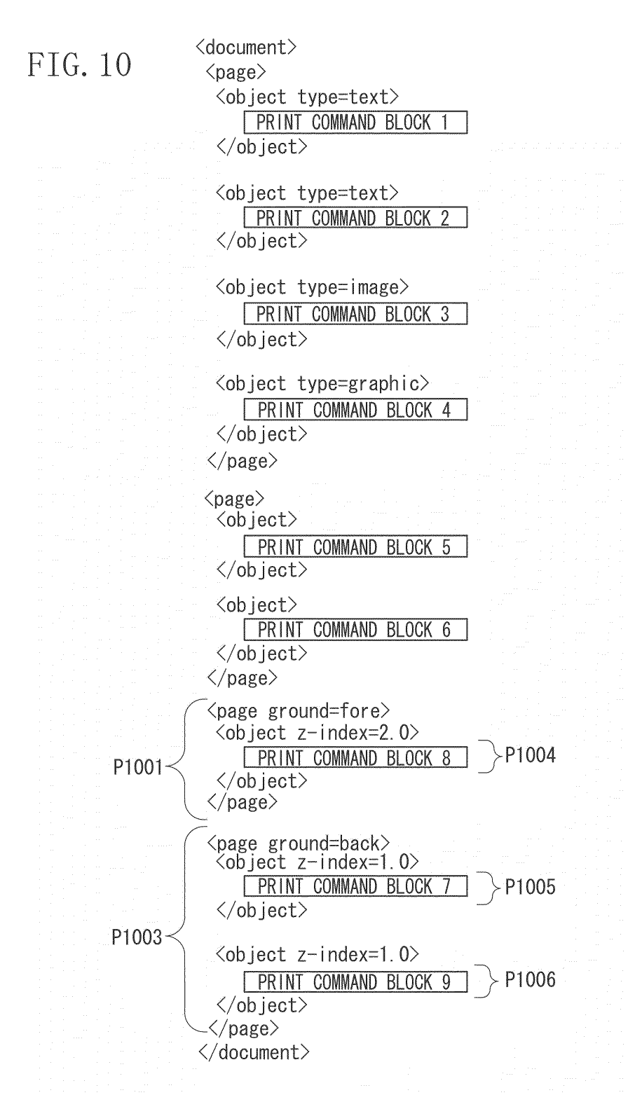

FIG. 10 illustrates PDL data obtained when completing the loop S904 performing the above-described processing on the PDL data illustrated in FIG. 4, in a case where only the third page has been set to be printed on a transparent recording medium. This PDL data includes a foreground page P1001 having a value “fore” as the “ground” attribute value and a background page P1003 having a value “back” as the “ground” attribute value. Among the three objects stored in an original page P407, the object P409 having the largest z-index value is stored in the foreground page as an object P1004. The objects P408 and P410 are stored in the background page as objects P1005 and P1006, respectively.

In the present exemplary embodiment described above, an image object having the largest z-index value is handled as the “foreground.” However, the present invention is not limited thereto. Example of other applicable methods include a method for handling an object having the smallest z-index value as the background, and a method for extracting objects so that the “foreground” and the “background” have the same number of objects.

Upon completion of the processing for extracting the foreground and the background from the PDL data, the processing proceeds to steps S908 and S909. In the method, image forming for the foreground is performed, similar to steps S508 and S509 illustrated in FIG. 5.

In step S910, the RIP processing unit 102 of the printing control apparatus 201 generates raster images after mirror image conversion on the page corresponding to the background. This processing is performed on the premise that “back” is specified as the “ground” attribute value of the page. The RIP processing unit 102 performs mirror image conversion and renders all of print commands within the page having this attribute value setting to generate raster images, and transmits the generated raster images to the image forming apparatus 207.

In step S911, the control unit 308 of the image forming apparatus 207 forms the image on the received raster images on the side opposite to the side on which image forming for the foreground was performed in step S909. More specifically, with the method according to the present exemplary embodiment, the image forming apparatus 207 does not perform mirror image conversion. In step S912, the printing control apparatus 201 determines whether printing has been completed for all pages. If printing has not been completed (NO in step S912), the processing returns to step S901. Then, the printing control apparatus 201 repeats the above-described print processing.

This completes descriptions of the method of image forming for print data on a transparent recording medium according to the present exemplary embodiment.

According to the present exemplary embodiment, since the printing control apparatus 201 automatically performs processing for extracting the foreground and the background from the PDL data, it is not necessary to make print settings for each print job. Then, mirror image conversion processing for the background is performed by the printing control apparatus 201. Thus, for example, in a case where the printing control apparatus 201 has higher processing speed than the image forming apparatus 207, print processing at higher speed is achieved.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-094766 filed May 1, 2014, which is hereby incorporated by reference herein in its entirety.

What is claimed is:

1. A printing apparatus comprising:
a printing unit configured to perform printing on a transparent sheet;
an extraction unit configured to analyze print data, and extract a first object to be printed on a front side of the transparent sheet and a second object to be printed on a back side of the transparent sheet; and
a control unit configured to control the printing unit so as to print image data generated from the first object extracted by the extraction unit, on the front side of the transparent sheet, convert image data generated from the second object extracted by the extraction unit into a mirror image, and print the mirror image on the back side of the transparent sheet.

2. The printing apparatus according to claim 1, wherein, based on types of objects in the print data, the extraction unit extracts the first object to be printed on the front side of the transparent sheet and the second object to be printed on the back side of the transparent sheet.

3. The printing apparatus according to claim 1, wherein, based on a print setting set in the print data, the extraction unit extracts the first object to be printed on the front side of the transparent sheet and the second object to be printed on the back side of the transparent sheet.

4. The printing apparatus according to claim 1, wherein the first object contains a text and graphics.

5. The printing apparatus according to claim 1, wherein the second object is an image.

6. A printing control unit for controlling a printing unit to perform printing on a transparent sheet, the printing control unit comprising:
an extraction unit configured to analyze print data, and extract a first object to be printed on a front side of the transparent sheet and a second object to be printed on a back side of the transparent sheet; and
a control unit configured to print image data generated from the first object classified by the extraction unit on the front side of the transparent sheet, convert image data generated from the second object classified by the extraction unit into a mirror image, and output the mirror image to the printing unit.

7. A method for controlling a printing apparatus comprising a printing unit for performing printing on a transparent sheet, the method comprising:
analyzing print data, and extracting a first object to be printed on a front side of the transparent sheet and a second object to be printed on a back side of the transparent sheet; and
controlling the printing unit so as to print image data generated from the extracted first object on the front side of the transparent sheet, convert image data generated from the extracted second object into a mirror image, and print the mirror image on the back side of the transparent sheet.

8. A non-transitory storage medium storing a program for causing a computer to execute a method for controlling a printing apparatus comprising a printing unit for performing printing on a transparent sheet, the method comprising:
analyzing print data, and extracting a first object to be printed on a front side of the transparent sheet and a second object to be printed on a back side of the transparent sheet; and
controlling the printing unit so as to print image data generated from the extracted first object on the front side of the transparent sheet, convert image data generated from the extracted second object into a mirror image, and print the mirror image on the back side of the transparent sheet.
